(19) United States
(12) Patent Application Publication
(10) Pub. No.: US 2007/0016494 A1
(43) Pub. Date: Jan. 18, 2007

(54) Methods of adjusting sales plans

(75) Inventors: Katherine A. Brown, Lake Elmo, MN (US); Lawrence J. Ptasienski, North Oaks, MN (US)

Correspondence Address: 3M INNOVATIVE PROPERTIES COMPANY, PO BOX 33427, ST. PAUL, MN, 55133-3427, US

(73) Assignee: 3M Innovative Properties Company

(21) Appl. No.: 11/167,667

(22) Filed: Jun. 27, 2005

(51) Int. Cl. G06Q 30/00

(52) U.S. Cl. 705/28

(57) ABSTRACT

A method of adjusting a sales plan using information gathered from an item monitoring system. In one embodiment of the a method of adjusting a sales plan, the method comprises the steps of: providing a sales plan related to items; providing an item monitoring system, comprising: at least one sensor, wherein the sensor senses a plurality of items in a first amount of space associated with the sensor, wherein the sensor is capable of sensing both items containing metal and items containing no metal; a communications network; and a computer, wherein the computer receives information from the sensor through the communications network; gathering information from the item monitoring system during a first instance; processing the information to determine the quantity of items within the first amount of space at the first instance; and adjusting the sales plan related to items based on the information processed.

### TECHNICAL FIELD

The present invention relates to a method of adjusting a sales plan using information gathered from an item monitoring system. The present invention relates more particularly to a method of adjusting a sales plan, comprising the steps of: providing a sales plan related to items; providing an item monitoring system, comprising: at least one sensor, wherein the sensor senses a plurality of items in a first amount of space associated with the sensor, wherein the sensor is capable of sensing both items containing metal and items containing no metal; a communications network; and a computer, wherein the computer receives information from the sensor through the communications network; gathering information from the item monitoring system during a first instance; processing the information to determine the quantity of items within the first amount of space at the first instance; and adjusting the sales plan related to items based on the information processed.

### BACKGROUND OF THE INVENTION

A variety of systems and other methods are known for monitoring inventory or items on shelves or in supply areas, or shelf-related systems for example those disclosed in U.S. Pat. Nos. 5,671,362, 5,654,508, 6,085,589, 6,107,928, and 6,456,067, France Publication No. 2575053, European Patent Publication No. 0670558 B1, Published Japanese Patent Application Nos. 10-243847 and 2000-48262. In addition, a variety of related sensing or detection devices are known, for example those disclosed in U.S. Pat. Nos. 4,293,852, 6,608,489, and 6,085,589.

### SUMMARY OF THE INVENTION

One aspect of the present invention provides a method of adjusting a sales plan. In one embodiment of the present invention, the method comprises the steps of: providing a sales plan related to items; providing an item monitoring system, comprising: at least one sensor, wherein the sensor senses a plurality of items in a first amount of space associated with the sensor, wherein the sensor is capable of sensing both items containing metal and items containing no metal; a communications network; and a computer, wherein the computer receives information from the sensor through the communications network; gathering information from the item monitoring system during a first instance; processing the information to determine the quantity of items within the first amount of space at the first instance; and adjusting the sales plan related to items based on the information processed.

One aspect of the above method further comprising the step of: recording the date and time when the information was gathered during the first instance. Another aspect of the above method further comprises the steps of: gathering information from the item monitoring system during a second instance; processing the information to determine the quantity of items within the first amount of space at the second instance and recording the date and time when the information was gathered during the second instance; determining a pattern of items leaving the first amount of space and adjusting a sales plan related to the items based on the pattern. In another aspect of the above method, the processing step comprises determining the location of the first amount of space.

In yet another aspect of the above method, adjusting the sales plan includes predicting when customers will most likely remove the items from the first amount of space and stocking items ahead of time to replenish the first amount of space with items. In another aspect of the above method, the sales plan may comprise one of the following: number of items ordered, shipped or received by the store; pricing of the items; or location of items within the store. In another aspect of the above method, the method further comprises charging manufacturers of the items premium prices for the ability to include their items in the amount of space in the store where the items are removed fastest by customers.

In yet another aspect of the above method, the pattern is determined without the use of point of sales information. In another aspect of the above method, the plurality of items within the first amount of space are a plurality of the same stock-keeping units.

Another aspect of the present invention provides an alternative method of adjusting a sales plan. In one embodiment of the present invention, the method comprises the steps of: providing a sales plan related to items; providing an item monitoring system, comprising: at least one sensor, wherein the sensor senses a plurality of items in a first amount of space associated with the sensor, wherein the sensor is capable of sensing both items containing metal and items containing no metal; a communications network; and a computer, wherein the computer receives information from the sensor through the communications network; gathering information from the item monitoring system during a first instance; processing the information to determine the quantity of items within the first amount of space at a first instance; gathering information from sources not related to the item monitoring system; and adjusting the sales plan related to items based on the information from the item monitoring system and the sources not related to the item monitoring system.

One aspect of the above method further comprising the step of: recording the date and time when the information was gathered during the first instance. Another aspect of the above method further comprises the steps of: gathering information from the item monitoring system during a second instance; processing the information to determine the quantity of items within the first amount of space at the second instance and recording the date and time when the information was gathered during the second instance; determining a pattern of items leaving the first amount of space and determining the influence of the non-item monitoring system information on the pattern. In another aspect of the above method, the processing step comprises determining the location of the first amount of space.

In another aspect of the above method, the non-item monitoring system information may comprise one of the following: types of people shopping within the store; advertisement located adjacent to the first amount of space. In yet another aspect of the above method, the processing step comprises determining the location within the store of the first amount of space.

In yet another aspect of the above method, adjusting the sales plan includes predicting when customers will most likely remove the items from the first amount of space and stocking items ahead of time to replenish the first amount of space with items. In another aspect of the above method, the sales plan may comprise one of the following: number of items ordered, shipped or received by the store; pricing of the items; or location of items within the store. In another aspect of the above method, the method further comprises charging manufacturers of the items premium prices for the ability to include their items in the amount of space in the store where the items are removed fastest by customers.

In yet another aspect of the above method, the pattern is determined without the use of point of sales information. In another aspect of the above method, the plurality of items within the first amount of space are a plurality of the same stock-keeping units. In another aspect of the above method, the pattern is determined without the use of point of sales information. In another aspect of the above method, the plurality of items within the first amount of space are a plurality of the same stock-keeping units.

One aspect of the present invention provides a method of monitoring items within a store. In one embodiment of the present invention, the method comprises the steps of: providing an item monitoring system, comprising: a sensor, wherein the sensor senses a plurality of items in a first amount of space associated with the sensor, wherein the sensor is capable of sensing both items containing metal and items containing no metal; a communications network; and a computer, wherein the computer receives information from the sensor through the communications network; gathering information from the item monitoring system; processing the information to determine the quantity of items within the first amount of space; gathering point-of-sale information related to the items, wherein the point-of sale information is gathered when items are sold and determine the quantity of items sold by the store; determining the difference between quantity of items removed from the first amount of space and quantity of items sold by the store.

In another aspect of the above method, the method further comprises the step of: activating an alarm to a user if there is a suspicion that some of the items have been stolen due to a large difference between the quantity of items removed from the first amount of space and the quantity of items sold by the store. In another aspect of the above method, the method further comprises the step of: recording the date and time when such information was gathered about the first amount of space. In yet another aspect of the above method, the processing step comprises determining the location of the first amount of space.

### BRIEF DESCRIPTION OF THE DRAWINGS

The present invention will be further explained with reference to the appended Figures, wherein like structure is referred to by like numerals throughout the several views, and wherein:

FIG. 1 illustrates a schematic view of one embodiment of an item monitoring system, which is useful in methods of the present invention;

FIG. 2 illustrates a perspective view of the shelf arrangement of FIG. 1 with the items removed from the shelves;

FIG. 2a is a cross sectional view of a portion of one of the sensors of FIG. 2 taken along line 2a-2a;

FIG. 2b is a cross sectional view of one of the sensors of FIG. 2 taken along line 2b-2b;

FIG. 3a illustrates a top view of one of the shelves with items of FIG. 1 taken along line 3a-3a;

FIG. 3b illustrates a top view like FIG. 3a with some items removed from the shelf;

FIG. 4a illustrates a top view of one of the shelves with items of FIG. 1 taken along line 4a-4a; and

FIG. 4b illustrates a top view like FIG. 4a with some items removed from the shelf.

### DETAILED DESCRIPTION OF THE INVENTION

Manufacturers of consumer goods, products, or items seek to maximize their revenues. Common ways to increase their revenues include increasing the number of items sold in a period of time (otherwise known as “sales velocity”), or by increasing the profit margin for each item sold by increasing the selling price and/or by reducing the costs of manufacturing or costs associated with the marketing and selling of their items. Since most consumer items are sold through retail establishments, manufacturers of consumer items will typically develop plans to help increase sales velocity or pricing related to their items, and in doing so, will typically use point-of-sale data, if available, and use data affiliated with orders to their factories from the retailers or distributors to determine average velocity of their items being sold, as well as time-based variations (such as seasonal or weekly variations), try to estimate the effects of advertising campaigns, different pricing, and various other activities which help promote sales of their items. Retailers also want to increase their sales revenues by increasing sales velocity of the items sold in their store, increasing the price of each item sold, and by increasing their fraction of the selling price.

Point-of sale data is commonly known in the industry as data collected at the sales registers at the time of the sale. For instance, when an item is scanned and sold at a sales register at a retail store, that sale is recorded, and at any given time, the store corporate headquarters can process its sales data to determine what items are being sold on a particular day, or what pattern of sales related to certain unique items are occurring over time. Point-of-sale data may a include SKU (as described in more detail below) or other identifying code, such as the UCC code, price, number of items, time/date of check-out, register of check out, store and so on. Point-of-sale data can be used by both retailers and manufacturers to determine patterns in the sales of their items, that can then or in-turn be used to predict the number of sales of such items, to help develop sales plans for selling such items or products, and hopefully, ultimately result in increased sales.

However, point-of-sale data is limited. Often, manufacturers and retailers use point-of-sale data that is gathered over a period of time. So, there is a need for data which is more timely, and which would enable the retailer or manufacturer to react more quickly to changes. In addition, retailers frequently have sales displays for a particular product or item at multiple locations in a store. For example, batteries might be placed in multiple locations: in the toy department, in electronics and in the hardware section. Point-of-sale data generally is not able to determine the location from which the item was taken by the customer. Also, point-of-sale data may measure when an item is sold, but it cannot measure when an item was removed from a shelf by a customer. Therefore, a shelf can be close to empty or empty of items, and a store manager will not be aware of the fact until the point of sale data is gathered and compared to inventory in stock. In addition, point-of-sale data may not be correct. For instance, when a sales clerk rings up ten jars of baby food, they will typically scan one jar and on the register multiply the price by ten, instead of individually scanning all ten jars of baby food, which helps speed up the time at the register. However, the ten jars of baby food may represent five different kinds of baby food sold under the same brand which may be five unique items or SKUs. And, when only one jar is scanned, the point of sale data reflects ten of that particular kind as being sold, not what has truly been sold to the customer. These errors in point-of-sale data can lead to errors in sales planning. Lastly, point-of sale data can not measure if a large number of products are suddenly removed from the shelf. Retailers would like to be aware of such change because it may indicate a theft may have occurred.

Out-of-stock items on store shelves are also a significant problem for retail stores and wholesale stores. If a customer is looking for a particular product on a shelf or in a display area and that particular product is out of stock, the retailer or wholesaler lost the opportunity to sell that product to the customer, ultimately resulting in lost sales. In fact, if the customer needs the product immediately, it's possible that he or she may leave the store and go to a competitive store to purchase the product, ultimately resulting in lost customers for that store that didn't have the product in stock. According to some industry studies, items that are frequently out of stock in retail stores include hair care products, laundry products, such as laundry detergent, disposable personal care items, particularly disposable diapers and feminine hygiene products, and salty snacks.

A typical retail store or wholesale store may have employees visually inspect the shelves or product display areas to assess what products need to be restocked, or reordered. Alternatively, such stores may have certain times of the week designated for when areas of the store will be restocked with products. However, due to the hundreds, thousands or even tens of thousands of different items in large retail establishments, manual methods of determining inventory are generally too slow to provide useful real-time information. In addition, manual methods are quite labor intensive and are often prone to error.

The present inventive methods provide manufacturers of product items and retailers new ways in which to gather data to optimize their sales plans. These methods provide more accurate and timely data, compared to point-of-sale data, which ultimately helps the manufacturers and retailers develop better sales plans. The data provided by these inventive methods is gathered by item monitoring systems within the stores that measure directly what items are on the store shelves or are being taken off the shelf by customers. Such data is particularly useful for adjusting the portion of the sales plan that specifies how and when shelves are to be restocked.

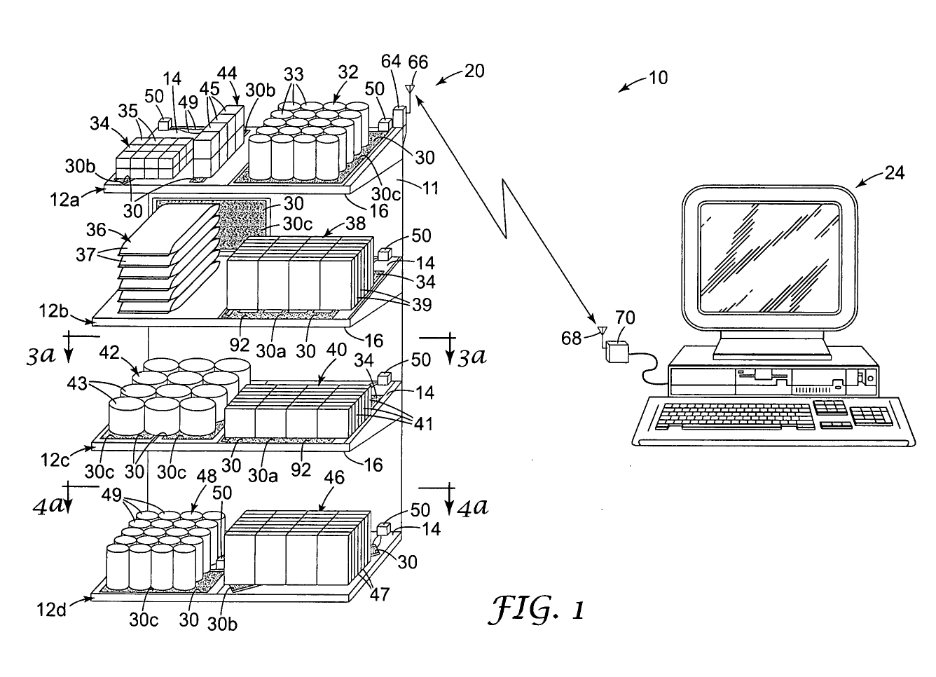

FIGS. 1-4 describe one example of a suitable item monitoring system 10 useful with the present inventive methods. This item monitoring system 10 provides an automated system to retailers and wholesalers with at least the following benefits.

First, the item monitoring system 10 provides information that is current, nearly current, or recently up to date, otherwise known as real-time information. Moreover, the item monitoring system can directly measure and provide quantitative information related to inventory levels of products on product displays or shelves.

Second, the item monitoring system 10 provides information about the products in the store, and in particular, provides information specific to each group of identical products or individual stock keeping units (“SKUs”), as they are commonly known in the industry. SKUs are commonly used to identify all the products offered in the store, depending on their brand, type, size, and other factors. Each unique type of product is generally assigned a unique alphanumeric identifier (an SKU). For example, one SKU designates Brand X Shampoo for Normal Hair, 15-ounce size. Another SKU designates Brand X Shampoo for Normal Hair, 20-ounce size. Another SKU designates Brand X Shampoo for Dry Hair, 15-ounce size. Another SKU designates Brand Y Shampoo for Normal Hair, 15-ounce size, and so on. This example helps illustrate that each shampoo type will have a different SKU, even if the shampoos are the same brand, for example, because they may differ in intended uses (“dry hair” versus “normal hair”) or differ in size (15 ounces versus 20 ounces). Frequently, a large retail establishment may utilize as many as 50,000 different SKUs to account for all the unique items in the store. That is, each product within a SKU is identical with respect to brand, size, color, shape, and other features such as flavor, fragrance, and intended use, for example, but the products with the same SKU may have variations in manufacturing date, shipping date, minor lot-to-lot color variation, and so on. Product displays or shelves in stores may include only one item, particularly for large in size or expensive SKUs, such as, for example, a bicycle. However, in general, for most consumer items, there will be a plurality of individual items displayed within each SKU and often a plurality of SKUs in a fully stocked display or shelf. The item monitoring system 10 provides quantitative information about how many items are on the shelf for each SKU.

Finally, the item monitoring system 10 does not require any changes to the consumer items or their associated packaging. The item monitoring system of this invention will detect items that are no different from items that are found in nearly every retail store today. In contrast, prior art systems have required the use of specialized devices attached to each product to track the movement of the products off the shelves, such as item-level labels, tags, antennae, or inserts or packaging materials employing materials or devices including, but not limited to, integrated circuits, magnetic materials, metallic materials or metal-containing parts, reflective parts, specialized inks, specialized films and the like. These prior art devices are typically undesirable because they often require significant and expensive changes for the product manufacturer, distributor or retailer to incorporate such devices into each and every product for the store.

FIG. 1 illustrates one preferred embodiment of the item monitoring system 10. The item monitoring system 10 is designed to provide information to a user concerning the number or quantity of items in a designated area or space, such as the space allotted to a group of like items, that is a group of items with the same SKU, on a portion of a shelf. The item monitoring system 10 includes at least one sensor 30, a communications network, and a computer 24. For the item monitoring system 10, there are a variety of suitable sensors 30, which are discussed in more detail below.

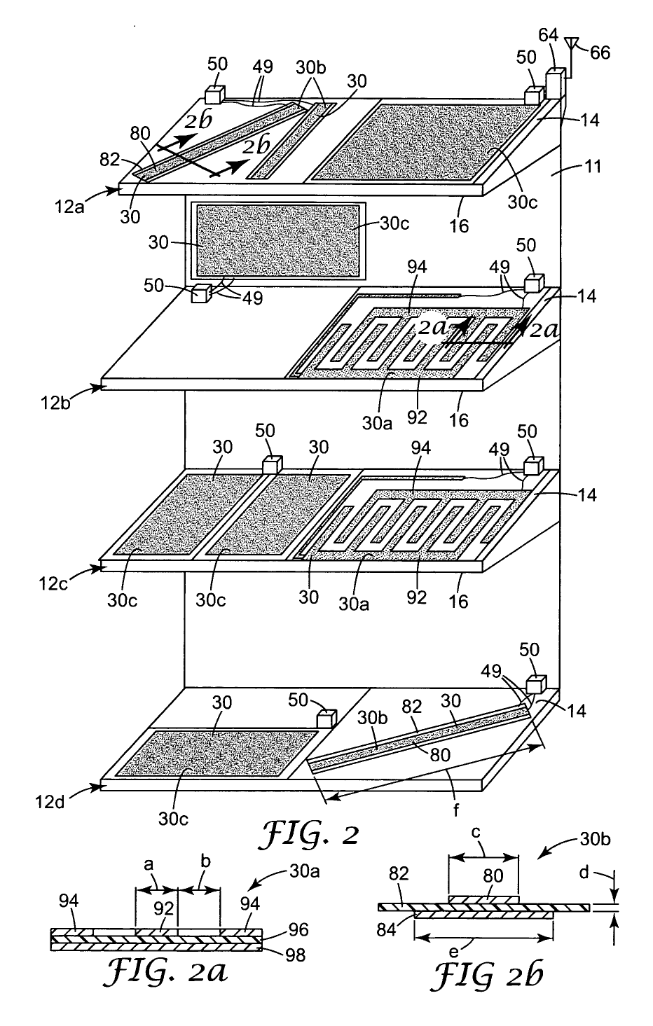

The item monitoring system 10 preferably includes a shelf arrangement 20, which includes a plurality of shelves 12. The shelf arrangement 20 illustrated in FIG. 1 and FIG. 2 includes a first shelf 12a, a second shelf 12b, a third shelf 12c, and a fourth shelf 12d. The shelves 12a-12d are all illustrated as mounted to a back panel 11. However, shelves 12a-12d may be just as easily mounted to a wall. Shelf arrangements 20 are commonly found in retail stores and other establishments. Therefore, it is possible to use existing shelving in stores to help minimize installation costs.

Each shelf 12a-12d in the shelf arrangement 20 includes at least one sensor 30 attached to it. The term “attached” and its variants as used herein means that the sensor 30 may be built into or is part of the shelf 12 itself, or it may be attached to either the top surface 14 or bottom surface 16 of the shelf 12, or it may be attached to a wall or panel 11 adjacent the items 12, physically integrated within an item display structure or set on top of a shelf. Attachment may be accomplished by mechanical means, such as mechanical fasteners, magnetic strips or the use of adhesives or a combination of these. Useful adhesives may be permanent or temporary, may include pressure sensitive adhesives, and may have additional features such as repositionability or clean removal.

The sensor 30 is preferably attached to a surface, such as the top surface 14 of a shelf 12, the bottom surface 16 of a shelf 12, or on a wall or panel 11 adjacent a shelf 12. Items are arranged on the shelves 12a-12b similar to how products are typically arranged on a shelf in a retail or wholesale store today, with like items all grouped together. Each item within a group has the same stock keeping unit or SKU, as explained in more detail above. Each group of items is positioned such that it is adjacent at least one sensor 30. For example, items 33 of a first SKU are positioned in group 32 in a first amount of space adjacent sensor 30c on the first shelf 12a. Items 45 of a second SKU are positioned in group 44 in a second amount of space adjacent sensor 30b on first shelf 12a. Items 35 of a third SKU are positioned in group 34 in a third amount of space adjacent sensor 30b on first shelf 12a. Items 37 of a fourth SKU are positioned in group 36 in a fourth amount of space adjacent the sensor 30c mounted on the back panel 11 adjacent the second shelf 12b. Items 39 of a fifth SKU are positioned in group 38 in a fifth amount of space adjacent sensor 30a on the second shelf 12b. Items 41 of a sixth SKU are positioned in group 40 in a sixth amount of space adjacent sensor 30a on the third shelf 12c. Items 43 of a seventh SKU are positioned in group 42 in a seventh amount of space adjacent two sensors 30c on the third shelf 12c. Items 47 of an eighth SKU are positioned in group 46 in an eighth amount of space adjacent sensor 30b on the fourth shelf 12d. Items 49 of a ninth SKU are positioned in group 48 in a ninth amount of space adjacent sensor 30c on the fourth shelf 12d. Although one preferred embodiment is illustrated in FIG. 1, shelf arrangement 20 may include any number of shelves 12, and any number of sensors 30 to monitor any number of various SKUs, so long as each sensor 30 may detect a multiplicity of items.

Although the item monitoring system 10 is illustrated as including a shelf arrangement 20, the system may include sensors 30 mounted to almost any surface that is not part of a shelf arrangement, such as the bottom or any side of a basket or bin, a countertop, a surface on the outside or inside of a case or cabinet, the top of a stand or table, or other surfaces that may be used to display or store items, so long as the items to be detected are placed within the sensing space associated with the sensor. Alternatively, the sensors 30 may also be mounted on suitable brackets, frames or other devices to secure the sensor 30 to a boundary of an area or amount of space containing items, where such area of space does not include a wall or other surface.

Some bulky consumer items may be packaged in packaging materials that are not rigid. One example is 50-pound bags of dog food, and another example is 40-pound bags of salt for water softeners. Such items are typically stacked on a shelf, as is shown in FIG. 1 for items 37 in group 36. For such items, it may be preferable to place sensors 30 on a back wall or panel 11.

Each sensor is designed to monitor a plurality of items within a designated area or amount of space. The phrase “amount of space” as used herein, including the claims, refers to the three-dimensional space or area where an item may be positioned within and the sensor 30 may detect its presence. For example, the sensor 30a on second shelf 12b monitors items 39 which are in the space directly above the sensor 30a. As another example, sensor 30c mounted on back panel 11 perpendicular to second shelf 12b monitors the space where items 37 are stacked in group 36. Because the item monitoring system 10 may use a single sensor 30 to detect multiple items, the number of sensors to be installed is minimized, thereby helping to minimize installation costs.

The sensors 30 may be any size. For example, the sensors 30 may be about the same dimensions as the “footprint” of the group of items above, below, or beside them, or the sensor 30 may be smaller than the footprint of the items above, below, or beside them. The sensors 30 may monitor the space related to the entire surface of the shelf 12, or may only monitor the space relating to a portion of the shelf 12. For example, the sensors 30 may only occupy the space along the front edge of the shelf 12 space closest to the customer. This arrangement is useful for notifying the store when the front of the shelf is empty of product. When the front edge of a shelf is empty, a retailer may wish to restock the shelf, or move the remaining inventory in that SKU forward to the front of the shelf, or both. To make a portion of the sensors 30 visible, the item monitoring system 10 in FIG. 1 is illustrated such that the items on the shelves 12 do not entirely cover the sensors 30 and as a result, some space is visible between the groupings of SKUs, however, the sensors 30 may be completely covered by items of the same SKU, when the shelf is completely stocked, and there need not be spaces between adjacent groupings of SKUs.

The sensors 30 should be able to detect, that is, provide a response to, a large variety of physical items with a wide range of physical characteristics, such as size, shape, density, and electrical properties. These items, which are typically products and their associated packaging materials, are made from a wide variety of materials including, but not limited to, the following: organic materials, such as foodstuffs, paper, plastics, chemicals; chemical mixtures, such as detergents; cosmetic items; inks and colorants; inorganic materials, such as water, glass, metal in the form of sheets, cans, foils, thin layers and devices, electronic components, and pigments; and combinations of these. This list of materials is not meant to be all-inclusive, but is given to illustrate that the variety of materials in such items is quite large. In particular, it should be noted that the inventory in most all retail stores includes some products and their affiliated packaging that contain metal and some products and their affiliated packaging that do not contain metal but contain other materials, such as plastic, etc. Therefore, the item monitoring system 10 is able to detect items containing metal, as well as items that do not contain metal. For example, some industry studies indicate that frequent out-of-stock items in retail stores include hair care products. Hair care products include items such as plastic shampoo bottles, which typically do not contain metal, and aerosol cans of hair spray, which typically do contain metal.

The item monitoring system 10 may include a variety of different sensors 30. One preferred sensor 30 is a planar capacitor sensor 30a. Another preferred sensor 30 is a sensor 30b that includes a waveguide. Another preferred sensor 30 is a photosensitive sensor 30c that detects light from lighting sources, including ambient light. Each of these preferred sensors 30a-30c provide a response that is related to the number of items in the space associated with the sensor. Each of these preferred sensors 30a-30c are described in more detail below. However, the item monitoring system is not limited to these preferred sensors 30a-30c. The item monitoring system may include any sensor known in the art that can sense a plurality of items in the space associated with the sensor.

The item monitoring system 10 shown in FIG. 1 includes sensor electronics 50. The combination of a sensor 30 and sensor electronics 50 is referred to as a sensing device. Typically, a sensing device 29 includes a sensor 30, and sensor electronics including a microcontroller 58, transceiver 60 and an optional battery 62. Optionally, sensor electronics 50 includes an antenna (not shown) that is electrically connected to transceiver 60.

The item monitoring system 10 shown in FIG. 1 includes a computer 24. Optionally, the item monitoring system 10 includes one or more nodes 64 and a transceiver 70. The system components that provide communication, including transceiver 60 in the sensor electronics 50, node 64, and transceiver 70, are together referred to as a communication network. Alternatively, the communications network may be any means known in the art for transferring information between the sensor 30 and computer 24.

The sensor 30, with the assistance of its associated sensor electronics 50, provides information to the computer 24 though the communications network. Preferably, this information is sent at time intervals such that the inventory information per SKU space or monitored space of the item monitoring system 10 is current or recently up to date regarding what items are on the shelves in the store.

The communication network preferably includes a node 64, which optionally includes an antenna 66. Preferably, node 64 is within the transmission range of the sensor electronics 50 associated with the sensors 30 and receives information from the sensor electronics 50. Generally, one or more nodes 64 are used to relay information from sensor electronics 50 to transceiver 70, particularly when the distance between sensor electronics 50 and transceiver 70 is greater than the transmission range of the transceiver 60 in the sensor electronics 50. Such information may be digital or analog data. Alternatively, node 64 may receive information from other sources and transmit that information to sensors 30 through sensor electronics 50. Node 64 may also process the data from sensor electronics 50. Examples of such processing include, but are not limited to, calculations or comparisons to interpret, simplify or condense the output of the sensor electronics 50. Optionally, node 64 may also store data sent by sensor electronics 50 for a period of time, or it may also store other data such as the time associated with a transmission from sensor electronics 50. The communications network may include any number of nodes to help transfer data from a large number of shelf arrangements 20, each shelf system having a plurality of sensors 30. One example of a suitable node 64 is commercially available from Microhard Systems, Inc., located in Calgary, AB, Canada as part number MHX-910.

Transceiver 70 and/or computer 24 may also be connected to other devices that interface with store personnel, suppliers, shipping or delivery personnel and so on, or to other devices or equipment that interface with computers, servers, databases, networks, telecommunication systems and the like.

Signals, commands and the like may be transmitted through the communications network via wires or cables, or they may be transmitted wirelessly, or it may be partly wired and partly wireless. At least a partly wireless communication network is preferred and completely wireless communications are more preferred for a variety of reasons. First, it helps to avoid the unsightly appearance of cables and wires running throughout the store. Second, wireless communication networks may be less expensive and easier to install. One example of wireless transmission is accomplished by the use of frequencies available in the United States Federal Communication Commission Industrial-Scientific-Medical (“ISM”) band, preferably in one of the ranges 300 to 450 MHz, 902-928 MHz and 2.45 GHz. Examples of standardized communication protocols useful for the communication network include: the 802.11 standards set by the Institute of Electrical and Electronics Engineers, Inc. located in Piscataway, N.J.; the Bluetooth standard, which was developed by an industrial consortium known at the BLUETOOTH SIG, located in Overland, Park, Kans.; and or proprietary ISM band communication network Those skilled in the art recognize that different frequency ranges may be utilized as appropriate. A proprietary (non-standardized) communication protocol may be preferred for transmission to and from sensor electronics 50.

Components of the communication network may be installed by attaching them to existing structures in a store, such as shelves, walls, ceilings, stands, cases and the like. In general, they will be installed at a spacing distance that will enable communication with every location in the store. However, it is within the scope of this invention to monitor only a portion of a store with the item monitoring system of this invention.

The item monitoring system 10 includes a computer 24. Computers 24 are well understood in the art. A variety of different software programs known in the art may be used to collect the information sent by the sensor 30 and sensor electronics 50 though the communications network. One example of suitable software for use on computer 24 is software commercially available under the tradename LabVIEW from National Instruments based in Austin, TX. This software is useful for creating views on the computer that display the current SKUs in stock on the shelf arrangements 20. Another example of suitable software is MICROSOFT brand software SQL Server from Microsoft Corporation located in Redmond, Wash. Alternatively, customized software may be preferred. Commercial or customized software is used to process, organize and present the information from the sensing devices in a user-friendly format. For example, the software may be designed so that the quantity of each group of SKUs is presented on a map of the store, showing the status of particular SKUs in particular locations. These displays may be customized to present data to and interact with different users who may have different needs or interest, for example, retailers and manufacturers. Many different information presentation formats will be apparent to those skilled in the art. The software may allow the retailer or supplier to set thresholds below which “time to restock” warnings are issued with either a visual or audible signal. The software may also be configured for periodic data collection from the sensor 30 and sensing electronics 50, or to collect data from the sensor 30 and sensing electronics 50 only upon request, or some combination thereof.

Each sensor 30 may have its own sensor electronics, or the sensing electronics 50 may be connected to more than one sensor 30. For example, sensor 30c on first shelf 12a has its own sensor electronics 50 (as illustrated more clearly in FIG. 2). Two sensors 30b on first shelf 12a share one sensor electronics 50. The sensor 30a on second shelf 12b and the sensor 30c mounted on the back panel 11 adjacent second shelf 12b each have their own sensor electronics 50. The two sensors 30c on third shelf 12c share one sensor electronics 50. The sensor 30a on third shelf 12c has its own sensor electronics 50. The sensor 30b and the sensor 30c on the fourth shelf 12d each have their own sensor electronics 50. Alternatively, the sensor electronics 50 may be hidden from a customer's view, such as mounted behind the panel 11. Each sensor electronics 50 is electrically connected to its associated sensor 30, for example, by wires 49 or physically attached to the sensor itself.

Preferably, sensor electronics 50 include at least a microcontroller and a transceiver, such as a radio frequency transceiver. However, sensor electronics 50 may include one or more components such as memory devices, a clock or timing devices, batteries, directional couplers, power splitters, frequency mixers, low pass filters, and the like. Other components may also be added to the sensor electronics 50 to form tank circuits, circuits for converting alternating to direct current, signal generators, phase detector circuits, and the like. The sensor electronics 50 may provide storage of a unique digital identifier for each sensor 30. The unique digital identifier is preferably a unique number, which is stored in a memory component, preferably a non-volatile memory component, such as an integrated circuit. This unique number may be associated with the SKU numbers in, for example, a database.

One preferred sensing device 29 includes a sensor 30 and associated sensing electronic 50. The sensor electronics includes a microcontroller 58 and a transceiver 60. The transceiver 60 is preferably a radio frequency transceiver. The sensor electronics may optionally include a battery 62. The sensing device 29 operation is controlled by the microcontroller 58 located in the sensor electronics 50. The radio frequency transceiver 60 is connected to the microcontroller 58 in the sensor electronics 50 and is used to communicate with the communications network, which may include the optional node 64, or optional transceiver 70, or communicate directly to the computer 24. (The node 64, transceiver 70 and computer 24 are all illustrated in FIG. 1). The optional battery 62 may power the sensor 30 and the sensor electronics 50.

One of the advantages of the item monitoring system 10 is that it can provide information to the user about the number of products on the shelves in the store at the SKU level. This is accomplished by having at least one sensor 30 responsive to approximately the same three-dimensional space that is occupied by a plurality of items or products all having the same SKU and associating the information from the sensor 30 with that space. For the embodiment illustrated in FIG. 1, each sensor 30 is responsive to a group of items within the same SKU. The sensors may be periodically polled for measurements related to their respective SKU spaces. A certain number of items may be removed from the space associated with sensor 30 after a first measurement, but before a second measurement made by sensor 30. As a result, there will be a difference between the first measurement and the second measurement by the sensor, which correlates to a difference in the number of items in the sensor's associated space at the first time and the second time. For example, the sensor 30c on first shelf 12a will provide two different measurements before and after some items 33 are removed from the first shelf 12a. As another example, the sensor 30a on shelf 12b will provide two different measurements before and after some items 39 are removed from the second shelf 12b. As another example, the sensor 30b on shelf 12d will provide two different measurements before and after some items 47 are removed from the fourth shelf 12d, and so on. The magnitude of the difference between two measurements relating to different numbers of items in the space associated with a sensor depends on the type of sensor, the sensor design, the type of items in the space, and other factors such as interference or noise. Each sensor 30 is optionally calibrated relative to the items within the same SKU, so that the item monitoring system 10 can determine more precisely how many items have been taken from the sensor space. Each sensor 30 is arranged to monitor items with the same SKU, so that they can provide information for each SKU stocked in the store. Multiple items sensed or detected by one sensor is also advantageous because it helps to minimize the cost and labor of fabrication and installation. It is easier to install one sensor 30 than to install multiple sensors to monitor one SKU space. Further, each device of this invention is not restricted to a particular size and thus, each sensor 30 can easily be sized so that it senses only one SKU space.

Preferably, the item monitoring system is able to monitor a large number of SKUs frequently. As is apparent to those skilled in the art, the data rate of the item monitoring system 10, which includes the data rate of the communication network and the data rate of the computer 24 illustrated in FIG. 1, will limit the amount of data per SKU, the number of SKUs and/or the frequency of collecting data. To elaborate, the number of SKUs multiplied by the amount of data per SKU multiplied by the frequency of data collection should not exceed the data rate of any one component of the item monitoring There are a large number of SKUs in large stores. Further, retailers want to monitor items often so that their information is as close to real-time as possible, which requires that the data collection is frequent. Therefore, it follows that a preferable way to keep the data rate of the item monitoring system 10 within the limits of the system components is to minimize the amount of data required per SKU at each collection event. To help minimize the amount of data per SKU that is processed by the item monitoring system 10, the output of each sensor 30 is preferably a simple variable value that provides information about the items it senses. By simple, it is meant that a single variable value can provide quantitative information without significant data manipulation, extensive calculations, large look-up tables, or comparison of a large number of data or values. The sensor 30 output signal could be an analog output, such as a voltage, current, resistance or frequency measurement. For example, a photosensitive sensor 30c that is a photovoltaic device provides a voltage response or current response based on the area of the sensor 30 that is covered by items (and thereby shielded or blocked from incident light). Therefore, a single voltage measurement from the photovoltaic device 30c is sufficient to provide a measure of the number of items present, preferably when the device 30c is calibrated as discussed in more detail below. A response that is linear or nearly linear relative to the number of items present in the space associated with the sensor 30 may be preferred to minimize data processing.

The item monitoring system 10 may include any type of sensor 30 known in the art that may sense a plurality of items in the space associated with the sensor 30. FIG. 2 is convenient for discussing at least three of the different preferred embodiments of the sensors in more detail. The three different preferred embodiments of sensor 30, which were briefly discussed above, are the capacitive sensor 30a, the sensor that includes a waveguide 30b, and the photosensitive sensor 30c. Each of these sensors is discussed in more detail below.

FIG. 2 illustrates one embodiment of capacitive sensors 30a on both the second shelf 12b and third shelf 12c. FIG. 2a illustrates a cross sectional view of a portion of one of the capacitive sensors 30a. The capacitive sensor 30a is preferably a planar, capacitive sensor, which is convenient for attaching to a surface, such as a shelf 12. More preferably, the capacitive sensor 30a is an interdigitated, planar capacitive sensor. Preferably, the planar capacitive sensor 30a includes non-metal substrate 96, such as a dielectric substrate, and a conductive material attached to the dielectric substrate. More preferably, the planar capacitive sensor includes two electrodes of conductive materials in the form of patterned metals 92, 94, such as copper or aluminum. Preferred patterns of such metal electrodes 92, 94 are illustrated in FIG. 2, however, other patterns are suitable.

A planar capacitor as illustrated in FIG. 2 may be fabricated by positioning electrodes 92, 94 on a non-metal substrate. In one embodiment, the electrodes 92, 94 consist of thin strips of adhesive-backed copper foil mounted on a thin sheet of plastic material. This type of structure is durable and relatively easy to fabricate by simple conversion processes. Other means of making suitable capacitive structures include etching of metal foil/polymer film laminates, and plating of metal patterns on flexible polymer substrates, optionally with the use of photoresists or printed resists to control the areas where metal is etched or deposited. Such additive, subtractive and semi-additive methods of fabricating metal patterns are well known to those skilled in the art. Alternatively, printing of conductive inks may form conductive patterns 92, 94. One suitable material for the non-metal substrate is a polycarbonate material commercially available under the tradename LEXAN available from GE Plastics located in Pittsfield, Massachusetts. These methods of making patterned metal may be used in continuous manufacturing processes. Roll-to-roll manufacturing processes may be preferred because they provide efficient, large-volume, low-cost manufacturing.

FIG. 2a illustrates a cross sectional view of one embodiment of the planar capacitive sensor 30a. The patterned conductive material 92, 94 are attached to the dielectric substrate 96, optionally by a layer of adhesive. An optional layer of metal 98, such as copper or aluminum, is attached to the dielectric substrate 96 opposite the patterned electrodes 92, 94. The layer of metal 98 preferably covers the majority of the dielectric substrate 96. This layer of metal 98 functions as a ground shield for the sensor 30a. When the two patterned electrodes 92, 94, acting as conductors, are driven with opposite potentials, the opposing currents set up electric fields between, above and below the conductive electrodes 92, 94. Any change in the dielectric constant of the volume occupied by the electric field will cause a change in the capacitive reactance of the sensor 30a. Additionally any change in configuration of the electric field caused by, for example, metal objects will cause a change in the capacitive reactance of sensor 38. The electrodes 92, 94 are electrically connected to a capacitance meter inside the sensor electronics 50. One example of a suitable capacitance meter is commercially available from Almost All Digital Electronics located in Auburn, Wash. under model number L/C meter IIB. This particular meter measures the output of an oscillator. The oscillator circuit of the meter operates at a frequency that depends upon the capacitance supplied by the capacitive sensor 30a. Measuring the frequency of an oscillator may be advantageous for detecting items that cause very small changes in the dielectric constant of the volume corresponding to the electric fields, for example, items that do not contain metal or items that are loosely packed and therefore in effect, contain a large portion of air.

In FIG. 1, every item in the group of items in the space associated with the capacitive sensor 30a has a dielectric constant value. Taken as a group, the items create a change in the electric field in the space associated with the capacitive sensor 30a, which ultimately affects the measured frequency of the oscillator. When a certain number of items are in the space monitored by the capacitive sensors 30a, this produces a particular electric field distribution in the space and as a result, there is a particular frequency measured on the oscillator. If the capacitive sensor 30a is calibrated, as discussed in more detail below, the item monitoring system 10 can determine the number of items in the space associated with the sensor 30a by the frequency measured. It is especially helpful when all the items in the group associated with the sensor 30a are relatively the same item, such as items with the same SKU, because such items all cause approximately the same change in electric field distribution.

An example of one embodiment of an item monitoring system includes a planar capacitive sensor 30a, where the number of items is determined based on the change in frequency. The conductive material 92 has a width that is designated by distance “a” on FIG. 2a. The conductive material 94 has a width that is designated by distance “b” on FIG. 2a. Distance “a” is preferably between 5 and 50 mm, and more preferably between 20 and 30 mm. Distance “b” is preferably between 5 and 50 mm, and more preferably between 20 and 30 mm.

The planar capacitive sensor 30a, in combination with sensor electronics 50, can be used to measure phase changes of the signal to determine the number of items in the sensor's space. Sensor electronics 50 injects a signal into sensor 30a and a portion of the signal is reflected back to the sensor electronics because of the presence of items. The sensor electronics 50 measure the phase difference between two signals, for example, by mixing the injected signal and the reflected signal together. The DC voltage level of the mixed output signal is related to the phase changes of the reflected signal, thus the phase changes are determined by measuring the DC voltage level of the mixed output signal. As with measuring frequency, the phase measurements are dependent on the capacitive created by the items in the space associated with the sensors. If the capacitive sensor 30a is calibrated, as discussed in more detail below, the item monitoring system 10 can determine the number of items placed in or removed from the space monitored by the sensor by the change in phase to the signal. It is especially helpful when all the items in the group associated with the sensor 30a are relatively the same item, such as items with the same SKU, because such items all have approximately the same affect in the resulting capacitive.

Alternatively, there may be two different types of items in the group of items in the space associated with the sensor 30a. Provided that the electrical properties of the two types of items are different enough that they will cause two distinctly different frequency changes or phase changes in sensor electronics 50, the item monitoring system 10 can determine which of the items have been removed from the shelf. Accordingly, any number of different types of items may be placed in the area monitored by the sensor 30a, so long as each type of item causes distinct frequency changes or phase changes and therefore, the system can determine what number and what type of item has been removed from the shelf by the customer.

FIG. 2 illustrates one embodiment of waveguide sensors 30b on both the first shelf 12a and fourth shelf 12d. FIG. 2b illustrates a cross sectional view of one of the sensors 30b. The sensor 30b includes a first waveguide portion 80, which is a conductive material, such as copper or aluminum. The first waveguide portion 80 is attached, for example, by adhesive, to a second waveguide portion 82 that is a dielectric material. The sensor 30b includes a third waveguide portion 84 which is a conductive material attached to the second waveguide portion 82 opposite the first waveguide portion 80. The third waveguide portion 84 functions as a ground plate for the sensor 30b. Alternatively, the waveguide portions 80, 84 may be conductive inks or other conductive materials known in the art.

Waveguides may be fabricated by means similar to those described above for fabricating capacitive sensors. It may be preferred to use a roll of copper or other metal tape (metal foil plus adhesive) in a roll of a suitable width. Such a roll of tape can easily be fabricated on site, to produce sensors of customized sizes.

The waveguide sensor 30b and associated sensor electronics 50detects the presence of the items in its corresponding space by using time-domain reflectometry techniques. Time-domain reflectometry (“TDR”) has traditionally been used for detecting discontinuities or fault locations on transmission lines or power lines. However, such techniques have not been used to determine the number of items in a designated area, such as on shelves in a store. In particular, in the waveguide design of this invention, there are fringing electric fields that extend above and to the sides of waveguide when an electromagnetic signal is sent through the waveguide. A signal generator, within the sensor electronics 50, is attached to the first waveguide portion 80, and the third waveguide portion 84, which may be optionally grounded through the sensor electronics. The signal generator sends out a short signal or pulse along the length of the waveguide, and the detector, which is within the sensor electronics 50 and connected to the waveguide, detects the signals reflected back along the waveguide. If items are in the space that contains the fringing electric fields around the waveguide, these items will disturb the transmission of the signal at that location and cause part of the signal to be reflected back to the detector. Any fraction of the signal that is not reflected by an item will be absorbed at the distal end of the waveguide. Therefore, by observing the number of reflections, the item monitoring system 10 can determine the number of items in the sensing space. It should be noted that the time elapsed between the time the signal is sent and the time a reflection is observed is related to the position of the item causing the reflection (i.e., the closer the item is to the signal generator, the shorter the time).

The waveguide 80 has a width that is designated by distance “c” on FIG. 2b. Preferably, the dimension “c” in FIG. 2b for first waveguide portion 80 ranges from 3 to 20 mm, dimension “d” of the second waveguide portion 82 ranges from 1.6 to 9.5 mm, and dimension “e” of the third waveguide portion 84 in FIG. 2 ranges from 15 to 100 mm. Dimension “f” in FIG. 2 of the waveguide portions 80, 82, 84 ranges from 0.05 to 2.0 meter. The design principles for waveguides are well known to those skilled in the art (see, for example, Pozar, David M., Microwave Engineering Second Edition, John Wiley & Sons, Inc., New York, 1998, Chapter 3, pp. 160-167, which is hereby incorporated by reference).

FIG. 2 illustrates one embodiment of photosensitive sensors 30c on the first shelf 12a, mounted on the back panel 11, on third shelf 12c and on fourth shelf 12d. Photosensitive sensors 30c include a photosensitive material. Preferably, the photosensitive sensor 30c is a photovoltaic sensor 30c. The photosensitive material responds to light in the space associated with the sensor 30c by producing a current, voltage or resistance change. For example, when the sensor 30c, which is a photovoltaic sensor, is polled during one instance, the voltage is at one measurement. Then, if one of the items 37 is removed from the stack 36 on shelf 12b, because there is now one less item 37 in the stack 36, the photovoltaic sensor 30c can absorb more light, generating a different measurement of voltage during a second instance. It is this change in the measurements between the first instance and the second instance that indicates the number of items 37 in stack 36 has changed. Likewise, if an item 33 is removed from group 32 on top of photosensitive sensor 30c on first shelf 12a, the photosensitive sensor 30c will register a different measurement, after the item has been removed than it registered before the item was removed, thus indicating that an item has been removed.

Photovoltaic sensors can be fabricated from P-type and N-type semiconductors, such as, for example, doped amorphous silicon. Preferably, these devices are made in a roll-to-roll process on flexible substrates, such as those commercially available from Iowa Thin Films, located in Boone, Iowa.

Other suitable inorganic and organic materials also give a photoelectric response, that is, they display an electrical property that is a function of the amount of light they receive, and may be used in photosensitive sensors 30c. For example, electrical resistance may change with increasing light exposure. Many such materials are known in the art, for example, selenium and selenides, such as cadmium selenide, metal sulfides, such as cadmium sulfide, and mixtures of photosensitizing dyes with poly-N-vinylcarbazole with trinitrofluorenone. These may be deposited or coated onto substrates (including flexible substrates) by various processes (including roll-to-roll processes). Particles of photosensitive materials may also be formulated into inks, which may then be printed or deposited onto flexible substrates. Many materials, such as those that have been developed for applications, such as solar energy collection and electrophotography, may generally be used in photosensitive sensors of this invention Calibration may be preferred for photosensitive sensors that are used in ambient light, because shelf height, width, and depth and as a result, the intensity of incident ambient lighting can change from item to item, from location to location within a store, from store to store, and so on. For example, a shelf, particularly a shelf that is not a top shelf, may have higher ambient light intensity at the front edge of the shelf and lower ambient light intensity at the back edge of the shelf. For such a shelf lighting situation, it may be preferable to position a sensor so that it senses only a portion of the shelf over which there is less variation in light intensity, or alternatively two sensors may be optionally calibrated and used to detect items in one SKU that are in positions (i.e., front and back) that have different ambient light intensities.

Optionally, each sensor 30 may be calibrated during the installation process and/or at one or more times after the initial installation process. Calibration may provide more accurate sensing or more accurate threshold-setting, or provide for detection of additional states. For example, consider the photosensitive sensor 30c, which is sensitive to ambient light. Since different stores or even different locations within a store may have different amounts of ambient light, an uncalibrated photosensitive sensor 30c may be designed and set to detect two states (“high” and “low”) over a wide range of conditions. With calibration to a particular environment, it may be possible that five states (“full,” “high,” “medium,” “low” and “empty”) are detected or any number of states. It may also be desirable to calibrate sensors 30 for specific SKUs, which might vary in size, electromagnetic properties and so on.

One preferred procedure for calibration of the sensors 30 includes the steps of: a) measuring a first signal from the sensor 30 after installation in a SKU space, but before any items are placed into the SKU space; b) setting the first signal as “empty” by the system software; c) filling the SKU space with the SKU items such that the entire sensor area is full of the SKU items; c) measuring a second signal from the sensor 30; and d) setting the second signal as “full” by the system software. The signal associated with other states may be determined by interpolation between the empty and full state without the need for further calibration measurements. Optionally, additional measurements may be taken for more states between the signals for “empty” and “full.” Calibration may be accomplished with sensors 30 that provide linear or non-linear responses over the range of “empty” to “full,” or may be accomplished with different numbers of SKU items (such as just one), or may be accomplished with only one in situ signal measurement, or may be accomplished with the use of devices other than the sensor (for example, ambient light intensity could be measured with a light meter) or may be accomplished in advance of installation, such as pre-calibration in a factory setting. Other calibration variations will be apparent to those skilled in the art.

Information may be gathered from each sensor 30 (i.e., about each type of SKU) at periodic intervals. Information may be gathered almost constantly or it may be gathered less frequently. Preferably, information will be gathered at intervals ranging from one minute to one day. It may be desirable to gather information at regular intervals, or it may be desirable to collect information at times to be determined by an individual such as the store manager, or when other systems or events trigger a need for information gathering.

The item monitoring system 10 provides quantitative-related information that is sufficient to distinguish between at least two inventory states, such as “high” and “low.” It is within the scope of this invention to set different thresholds for “high” and “low”, but as an example, “high” might be defined as any amount of items greater than 40% of the full capacity of a SKU space, and “low” might be defined as any amount of items less than 40% of the full capacity of that SKU space. Preferably, the system will provide the user with the ability to choose from a range of threshold values from 5% to 95%. As previously discussed, it is not as useful to the retailer to detect only “empty” (and, by inference, “not empty”) because when the “empty” signal is generated, the item is already out-of-stock and will remain out-of-stock for some period of time (at least the time it takes to get more inventory to the shelf). Thus, item monitoring system 10 is able to detect varying inventory levels per SKU space, including a “low” state that is non-zero or non-empty. Quantitative information may be as accurate as an actual count of the number of items in the space of each sensor 30.

Preferably, an SKU space will be at least partially monitored by a sensor 30. That is, the sensor 30 is preferably larger than the size of the individual objects of a SKU to be sensed and is responsive to objects in some portion of a space associated with the sensor 30. Some retailers may prefer to place items only on the front half of a shelf. Alternatively, the shelves may be spring-loaded or gravity-fed shelves or displays, wherein items are moved to the front of the shelf by springs or gravity as soon as other items are removed from the front of the shelf. Thus it may be advantageous to arrange a sensor on a selected portion of an SKU space, such as a front portion.

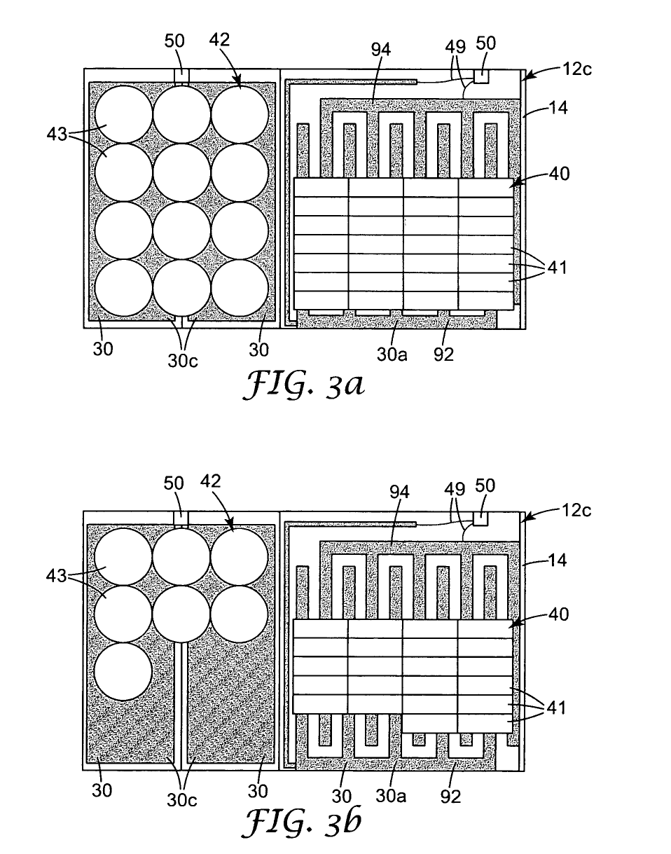

FIGS. 3a and 3b, respectively, illustrate the top of the third shelf 12c before and after a customer has removed items. In FIG. 3a, items 41 are arranged in a group 40 towards the front of the shelf 12c, closest to the customer. In this arrangement, the sensor 30a of the item monitoring system 10 could be calibrated to read “full.” In FIG. 3b, six of the items 41 have been removed. Since the sensor 30a was calibrated to read “full” with twenty-eight items in its space, the system will determine a reading of about 79% full, or this determination could be rounded to the nearest quartile to read about 75% full. When enough items 41 are removed from the shelf 12c, for example, fourteen items 41 in total, the item monitoring system 10 may read that the SKU space is now about 50% full. Once the SKU space drops below 50% full, the item monitoring system may send an appropriate signal to the user.

A single sensor 30 may be sized and positioned so as to sense all or only some of the space occupied by a single SKU. For example, as illustrated in FIG. 3a, items 43 of the same SKU are arranged in group 42, which is monitored by two sensors 30c. Four of the items 43 are in the space of both sensors 30c, specifically placed along the area where the two sensors 30c meet. Appropriate calibration and data processing may be used to rectify the data from two sensors to give a quantitative indication of inventory. For example, he combined output of sensors 30c are together calibrated to read as “full” in the arrangement illustrated by FIG. 3a. In FIG. 3b, five of the items 43 have been removed by the customer from shelf 12c. Since, the combined output of the two sensors 30c were calibrated to read “full” with twelve items 43, the combined output of the sensors 30c together will be interpreted to mean about 58% full with seven items, or this result may be rounded to read about 60% full. When enough items 43 are removed from the shelf 12c, for example, nine items 43 in total, the combined output of sensors 30 together will be interpreted to 25% full, and send a message to the user that items 43 need to be restocked on the shelf 12c (if the user had selected 25% as the threshold for sending a restocking message). Alternatively, each sensor 30c can be individually calibrated to read “full” when each sensor 30c includes a total of four entire items 43 and half of four additional items 43, for which the collective sensor response is calibrated to mean six items 43. In this arrangement, the sensor 30c on the left in FIG. 3b will sense a total of four items 43 (three entire items 43 and two half items 43) and read “66% full”. The sensor 30c on the right in FIG. 3b will sense a total of three items 43 (two entire items 43 and two half items 43) and read “50% full”.

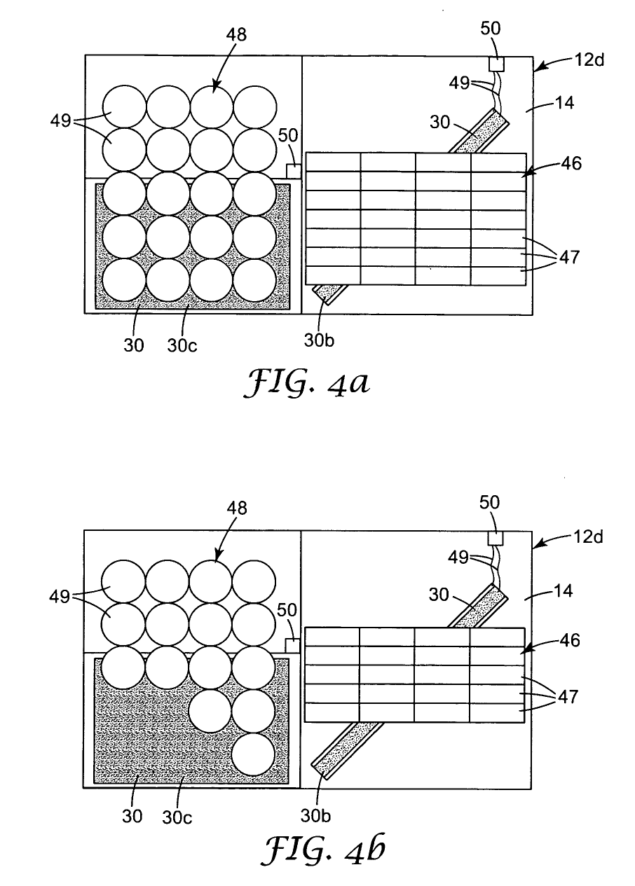

FIGS. 4a and 4b, respectively, illustrate the top of the fourth shelf 12d before and after a customer has removed items. In FIG. 4a, sensor 30c monitors only the front half of the shelf 12d. Typically, customers will remove items from the front area of the display or shelf, selecting items further back once the front area of the shelf is empty. When the front area of the shelf is completely full, as is illustrated in FIG. 4a, the sensor 30c may be calibrated to mean that the area associated with the sensor is “100% full.”In FIG. 4b, five of the items 49 have been removed. Since the sensor 30c was calibrated to read “full” with twelve items 49 in its associated sensing space, the sensor 30c will provide an output that can be interpreted to mean that the space associated with the sensor is now about 58% full, or this interpretation could be rounded to mean about 60% full. When enough items 49 are removed from the shelf 12d, for example, twelve items 41 in total, the sensor 30c output may be interpreted to mean that the space associated with the sensor is now 100% empty. The item monitoring system may then send a message to the user that items 49 need to be restocked on shelf 12d. Utilizing a sensor covering only part of a SKU space may be especially advantageous when the inventory level corresponding to the empty sensor space is about the same as a desired threshold level for restocking. Alternatively, the item monitoring system may send a message to the user that it is time to move items forward to the front of the shelf, and may be useful for those situations where a store owner or store manager prefers to keep shelves “faced” (that is, with all items in a SKU space positioned as close to the front of the shelf as possible, so as to create a neat appearance and to make it convenient for customers to reach items). Note that, in this particular example, there may be items 49 on the shelf 12d for a customer to purchase, even when the space associated with the sensor is interpreted by the system to be empty.

In FIG. 4a, items 47 are arranged in a group 46 towards the front of the shelf 12d, closest to the customer. In this arrangement, the sensor 30b of the item monitoring system 10 could be calibrated to read “full.” In FIG. 4b, eight of the items 41 have been removed. Since the sensor 30b was calibrated to read “full” with twenty-eight items in its space, the sensor 30a will read about 71% full or could be rounded to read 70% full. When enough items 47 are removed from the shelf 12c, for example, fourteen items 47 in total, the sensor 30b or the item monitoring system 10 may read that the SKU space is now about 50% full. Once the SKU space drops below 50% full, the item monitoring system may send a signal to the user that items 47 need to be restocked on shelf 12d.

Sensor 30b in FIG. 4a and 4b is arranged diagonally across the SKU space. Sensor 30b will only detect items that are within the fringing fields adjacent the first waveguide portion 80. Thus, most of the items in the SKU space will not be directly measured. However, customers generally remove items from the front of the shelf first, and while the patterns of removal are not exactly the same each time, they are sufficiently consistent so that one can measure only those items in close proximity to first waveguide portion 80, making the assumption that each row of items is removed entirely before items are removed from the row behind it, and determine the approximate number of items in the SKU space to a useful level of accuracy.

Each SKU space is illustrated in the figures as occupying about half of a shelf, but it should be understood that generally a single SKU may occupy a range of widths on a shelf from as small as about 1 cm wide up to the full width of the shelf. Sensors may be of various sizes to fit the wide variety of SKU sizes and shapes. Even if only part of the space occupied by a single SKU contains a sensor, it is still able to provide useful information that may be used to adjust the sales plan, as discussed in greater detail below.

Preferably, the item monitoring system 10 provides current or real-time information about the number of physical objects associated with each sensor 30, at the SKU level. Real-time information is defined as information that accurately represents the true state during the time data is gathered and processed, or within a small amount of time of the time that the data is gathered and processed. In other words, the information is current or very nearly current. The definition of a “small amount of time” is dependent on the application, but will generally be less than one-half, preferably less than one-tenth, of the reaction time required by the retailer for any action resulting from adjusting the sales plan. For example, it if takes 20 minutes to move an item from one location in a store to another, it would be considered real-time information to know what the status of that shelf was within ten minutes. In actual use, a retailer may decide to gather real-time information infrequently, for example, one time per day, but nonetheless the information is real-time because it accurately reflects the status of the SKU at the time it was gathered. As will be apparent to those skilled in the art, the exact performance of the system will depend on the number of SKUs monitored and the amount of data per SKU.

The item monitoring system 10 can easily be installed at several locations within a store, for example, on a shelf, on an end cap, and at a checkout stand. It may be preferable to monitor certain locations because they are prominent and/or frequently result in higher sales. Further, it may be useful to monitor items that are displayed for sale in several locations in the store. When items are on sale or are being promoted with coupons, advertisements and the like, for example, they are often displayed in several locations within the store (including the usual location for that SKU, but typically some additional, prominent locations). It may be preferable to use the item monitoring system of this invention to determine if restocking is necessary, and to determine the locations with the highest sales velocity.

The item monitoring system 10 may further include specialized sensing devices with different features or employing different technologies, to provide inventory information on specialized items such, as very expensive consumer electronics. Such specialized sensing devices may incorporate one or more sensors to detect a single item, or may require specialized tagging of items, such as RFID tags on each item. It may be advantageous to add such specialized sensing devices to the system 10, for example, to take advantage of the communication network.

One example of suitable item monitoring system 10 useful in the present inventive methods is described in U.S. patent application Ser. No. 10/788,061, “An Item Monitoring System and Methods of Using an Item Monitoring System (Brown et al.), which is hereby incorporated by reference.

The present inventive methods are useful with the item monitoring system 10 described above. As mentioned above, these inventive methods are useful for helping manufacturers or retailers in adjusting their sales plans related to those product items to help them optimize their sales of such items based on data related to what product items are being removed from the shelves in the store by the customer. A business plan may specify actions, procedures, messages and the like that are related to executing the plan. For example, a business plan may specify that a replacement order be placed when inventory of an item drops to a threshold level, or it may specify that a notice be sent to store personnel indicating that an item needs to be restocked from the store's back room. Actions such as restocking shelves are examples of execution of the plan.

As described above, the item monitoring system 10 senses the plurality of items in the first amount of space at a first instance with at least one of the sensors and the computer determines the quantity of items within the first amount of space associated with the sensor. The sensor 30 may then sense the plurality of items in the first amount of space associated with the sensor at a second instance, for example, a few minutes later or an hour later than the first instance, and determine the quantity of items in the first amount of space during this second instance, and optionally compare it to the quantity of items that were in the first amount of space during the first instance, to see if the number of items has changed. The information gathered at the first instance and second instance from the sensors 30 can be sent by the sensor electronics 50 through the communications network to the computer 24. After a series of measurements have been taken over time, patterns or trends in the numbers of items on the shelves can be determined, which is useful in the inventive methods described below.

In addition, in one embodiment, when the sensors 30 sense the plurality of items in the first amount of space, the associated time and date of when the measurement was taken is recorded by the item monitoring system 10. This may be accomplished by the computer 24, using a clock in the computer using a clock in the sensor or another device. Alternatively, the computer may receive inventory data from the sensors 30 that is already associated with time and date data. The process of sending a signal and receiving inventory information from the item monitoring system 10 is repeated. This process may be automated and performed at regular intervals (for example, at one minute intervals), or specific times may be selected in advance (for example, every hour on the hour), or specific individual signals may be sent when so desired by a user who is using the system. A collection of data is thereby produced that consists of the inventory measurements of items on the shelves associated with times and dates when the measurements were taken.

In addition, in another embodiment, when the sensors 30 sense the plurality of items in the first amount of space, the location of the first amount of space may also be recorded. For instance, one sensor 30 may be affiliated with the third shelf in row one of a store, where another sensor 30 may be affiliated with the end cap of row five of the store. Collection of data related to the location of the sensors 30 is especially useful for determining location specific velocity data. For example, both locations in the store (the third shelf of row one and the end cap of row five) may display batteries on sale. However, the batteries located on the end cap may be removed by customers faster, due to its easy accessibility and increased visibility, in comparison to the location in the row. POS data collection systems generally do not provide for a means to determine sore location related information for items so processed. Data from such a data collection system generally can only provide overall inventory information while the item could be out of stock at a specific location. An adjustment could be made to the sales plan, such as increasing the retail space on the end cap devoted to batteries. In the example above, the store has 50% of its full inventory of batteries left, but most of the batteries in the end cap are gone, whereas nearly all the batteries on row one are still on the shelf. This is a missed opportunity to move the batteries from the row one location to the end cap location in order to increase the availability of the batteries to the customers, and ultimately increase the number of sales of batteries.

The computer processes the data gathered by the inventory monitoring system 10. Processing could include identifying a single data point, such as a particular SKU inventory, or multiple data points, for example comparison of the same SKU inventory in multiple locations, or selecting data on items that are on sale or part of a promotion. Processing could also be performed on multiple data points collected at regular intervals over a period of time, and displayed as accumulated data over the same or a different interval to determine patterns or trends in the number of items leaving the spaces monitored by the sensors 30 on the shelves. This information is helpful to use in adjusting sales plans related to products offered in the store. For example, data could be collected hourly, and processed to show the average number of items leaving the shelves per day.

The processing of the data gathered by the item monitoring system 10 may provide a variety of information to a user. For example, the inventory data could be processed to show average velocity of items leaving the shelves by day of the week, by comparing the number of items present at the end of each day, versus those present at the beginning of each day, taking into account the number of items that are added to the SKU location by restocking during each day (which could be measured by the same item monitoring device or obtained from other sources, for example, data entered by the person doing the restocking). In another example, data could be processed to show velocity of items leaving the shelves by the time of each day of the week. In another example, velocity for a group of similar or related items leaving the shelves could be processed to show seasonal variations, that is variations by week over a period of 52 weeks. In another example, data could be processed to show inventory on the shelves and velocity of items leaving the shelves for a particular item at different locations throughout a store.

In another embodiment, the information gathered by the item monitoring system 10 and processed to predict when customers will most likely remove items from the shelves may be used to adjust sales plans related to the items.

Another aspect of the present invention is a method of gathering data on in-store inventory, analyzing the data and using it for automatic, real-time optimization of sales plans, one example being keeping the shelves stocked with items for sale to a customer. The processed data may be used to make a real-time adjustment to preexisting sales plans. For example, the velocity of an item may be determined to be much higher today than on an average day, so a sales plan adjustment maybe an order for another shipment of this item immediately. Placement of such an order to a distribution center may be made without human intervention. In another example, a particular item is displayed at three different locations in a store. Alternatively, pricing may be changed out automatically without human intervention. The collected data may show the velocity of the item being removed from the shelves over the past three hours in location 1 has been 0.2 units per hour and there are 50 items present in that location. The velocity in location 2 has been 7 units per hour and 20 units are present, and that the velocity in location 3 was 30 units per hour for almost two hours, until there were no items left in that location. This may lead to a modification on the sales plan to stock higher levels in location 3 and lower or no levels in location 1. Further, a message may be sent to the store manager (via computer, wireless device, cell phone, or other communication device) instructing him of the changed sales plan and to move items from location 1 to location 3 as soon as possible.

Many methods of processing collections of data are well known to those skilled in the art. Methods of calculating and illustrating the processed data include, for example, use of spreadsheets, graphs and summary sheets. Data may be processed to yield averages (for example, the average number of units sold per hour over a month), or it may be useful to process the data to yield means, distributions, exceptional data points (outliers) and so on.

The processed data from the item monitoring system 10 may be used by a person (for example, a retail store manager or a product marketing manager at a manufacturer) to adjust a preexisting sales plan or to develop a new sales plan related to the particular item(s) being monitored by the system. A sales plan may include any of the following: the number and timing of unique items (commonly referred to as stock keeping units or SKUs) to be ordered, produced, shipped or received by the store; the product mix on the shelves (i.e., the amounts of several related SKUs, for example, scented and unscented laundry detergent); ordering procedures or business rules for placing orders for items and for returning items to a distribution center, warehouse or manufacturer; pricing of items; location and/or means of display of items within a store, including multiple locations, aisle displays, checkout lane displays, end caps and the like; amount of space used to display a item; communications to potential customers, such as advertising in newspapers, on the radio, or on television, by direct mailing, announcements in the store, and use of various other forms of media; coupons, rebates and other special offers related to the items; plans that will influence store employees' behavior, for example, the items sales personnel are instructed to promote in one-on-one interactions with customers, sales incentives, or the priority for restocking of items by employees; arrangement of items, for example, items which are given priority for facing (moving the item(s) to the front of a shelf where the item(s) is more accessible to a customer) or the location of items that are perishable and near expiration; location of high-margin items, cross-marketing (co-location of items that might be purchased in combination, such as hot dogs and hot dog buns); and so on. Sales plans may account for seasonally variations, for example, a plan made specify a larger amount of wrapping paper before Christmas. Sales plans may specify financial arrangements between a retailer and a manufacturer or shipper. For example, a sales plan may specify an amount of money that a manufacturer may pay to the retailer to have his products displayed in a desirable location in the store, such as where the items are removed most frequently by customers, or the amount a retailer receives from a shipper for a late delivery.

As one example, a product marketing manager observes from the processed data that the inventory of a particular item is zero (that is, the item is out of stock) by 2:00 PM on 50 out of 52 Saturdays. The store in which this product is sold is open until 9:00 PM, so he modifies his sales plan to increase the number of that item in his Saturday shipments in anticipation of restocking the item on the shelves around 2:00 PM. He might further see that the two Saturdays when that item did not go out of stock were during Saturdays near holidays, so he further modifies his sales plan so that those two shipments on future Saturdays located near holidays will not be increased.

In another example, a retail store manager sees from the processed data that the velocity of Item A leaving the shelves is much higher in locations 1 and 2 in his store, while Item A has a very low velocity in another location 3. He also sees that Item B has a very high velocity from a location immediately adjacent to location 3. He modifies his sales plan to use a smaller portion of location 3 for Item A, and to fill the rest of the space adjacent with Item B.

In another example, a retail store manager sees from the processed data that the velocity of Item C averages 20 units per hour after 5:00 PM on weekdays, but only 5 units per hour before 5:00 PM. He also sees that Item D is out of stock by 5:00 PM on weekdays, but before it runs of stock it averages 30 units per hour. Item D and Item C are identical products except that C is unscented and D has an added fragrance. Based on the data, he concludes that his customers prefer Item D and only buy Item C typically when D is out of stock. He modifies his sales plan to place larger orders for Item D and smaller orders for Item C in the future.

The present inventive methods could be used for intermittent or occasional projects to improve sales plan and financial performance, or it could be used repeatedly and regularly. The present inventive methods could also be used to predict future likely situations, by processing sufficient data collected over sufficient time to provide a history of data that is sufficiently reliable to determine trends and future behavior related to the removal of items by the customers. Such predictive information can be used to adjust, for example, the amount of certain items ordered by a particular store prior to a particular local event that helps increase sales of those items.

In other embodiments, the predictive information could be based on inventory data gathered by the item monitoring system 10 alone, or could be based on the inventory data combined with other data provided by sources other than the item monitoring system. For example, data on the demographics of a store's customers could be combined or processed together with data gathered by the item monitoring system 10 to optimize sales plans. Other data not related to or gathered by the item monitoring system can include the following: point-of-sale data; data on store demographics and usage patterns; data from customer surveys; data on the weather; data concerning the placement of advertising signs in the store; an economic profile of a particular store's customers; advertising and marketing plans (promotions); general economic data such as gasoline prices; credit card data; store loyalty program data; distribution center inventory data; shipping data (for example, advance shipping notices); employee data such as sales incentives earned or who worked during a particular time period; historical sales data; or event-driven data, for example, the occurrence of a natural disaster, a news article or TV report about the health benefits of certain items, such as sunscreens or healthy foods, or a product recall, and the like.

For example, the inventory data in a first collection of data gathered by the item monitoring system could be processed to determine the velocity of a number of items during those times when the data from a source other than the item monitoring system indicates that many of the shoppers in the store are mothers accompanied by small children. The combination of the processed data is used by a person to adjust a sales plan. For example, the locations of item as specified in a sales plan might be changed so that items that have a high velocity when mothers with small children are shopping are placed in locations that are most convenient to those shoppers. In another example, the inventory data could be processed to determine the velocity of an item when a particular advertisement or sign is placed adjacent to it and, optionally, the velocity of that same item in a different location with a different advertisement. The sales plan might be adjusted to utilize exclusively the advertisement that resulted in higher sales. In another example, inventory data might be combined with point-of-sale data and/or shipping data and processed to compare in-store inventory data to point-of-sale data, or to look for exceptions that indicate a problem. In another example, inventory data gathered over a period of time might show a higher velocity than the velocity indicated by point-of-sale data over the same period of time, suggesting that items are being stolen; a sales plan might be modified to place those items behind a counter to deter theft. For instance, if there is a large difference between the quantity of items removed from the shelves and the quantity of items sold over some time frame, it may indicate that such items were stolen, and an alarm may be sounded to store personnel. In yet another example, inventory data might be combined with point-of-sale data to determine the time elapsed between the time an item is removed from the shelf by a customer and the time it is purchased.

In yet another example, inventory data combined with point-of-sale data might indicate that certain items spend very little time in shopping carts, suggesting that such items are purchased by shoppers who want to get into and out of the store quickly. A sales plan might be modified to locate these items near an entrance or check-out lane or the sales plan might be modified to locate such items adjacent to related items that a customer might purchase if so conveniently located.

In another embodiment, data can be gathered and processed by the item monitoring system to provide information about what locations throughout the store have the greatest velocity of items leaving the shelves. One source of revenue for retailers is the amount they charge to manufacturers for the placement of the manufacturer's products in particularly advantageous locations in their stores. Such placement and fees could be part of a sales plan. Retailers could use the inventory data gathered to modify their rates charged to manufacturers for those premium locations.

The present invention has now been described with reference to several embodiments thereof. The foregoing detailed description and examples have been given for clarity of understanding only. No unnecessary limitations are to be understood therefrom. All patents and patent applications cited herein are hereby incorporated by reference. It will be apparent to those skilled in the art that many changes can be made in the embodiments described without departing from the scope of the invention. Thus, the scope of the present invention should not be limited to the exact details and structures described herein, but rather by the structures described by the language of the claims, and the equivalents of those structures.

1. A method of adjusting a sales plan, comprising the steps of:
providing a sales plan related to items;
providing an item monitoring system, comprising:
at least one sensor, wherein the sensor senses a plurality of items in a first amount of space associated with the sensor, wherein the sensor is capable of sensing both items containing metal and items containing no metal;
a communications network; and
a computer, wherein the computer receives information from the sensor through the communications network;
gathering information from the item monitoring system during a first instance;
processing the information to determine the quantity of items within the first amount of space at the first instance; and
adjusting the sales plan related to items based on the information processed.

2. The method of claim 1 further comprising the step of:
recording the date and time when the information was gathered during the first instance.

3. The method of claim 1, further comprising the steps of:
gathering information from the item monitoring system during a second instance;
processing the information to determine the quantity of items within the first amount of space at the second instance and recording the date and time when the information was gathered during the second instance;
determining a pattern of items leaving the first amount of space and adjusting a sales plan related to the items based on the pattern.

4. The method of claim 1, wherein the processing step comprises determining the location of the first amount of space.

5. The method of claim 1, wherein adjusting the sales plan includes predicting when customers will most likely remove the items from the first amount of space and stocking items ahead of time to replenish the first amount of space with items.

6. The method of claim 1, wherein the sales plan may comprise one of the following: number of items ordered, shipped or received by the store; pricing of the items; or location of items within the store.

7. The method of claim 1 further comprises charging manufacturers of the items premium prices for the ability to include their items in the amount of space in the store where the items are removed fastest by customers.

8. The method of claim 3, wherein the pattern is determined without the use of point of sales information.

9. The method of claim 1, wherein the plurality of items within the first amount of space are a plurality of the same stock-keeping units.

10. A method of adjusting a sales plan, comprising the steps of:
providing a sales plan related to items;
providing an item monitoring system, comprising:
at least one sensor, wherein the sensor senses a plurality of items in a first amount of space associated with the sensor, wherein the sensor is capable of sensing both items containing metal and items containing no metal;
a communications network; and
a computer, wherein the computer receives information from the sensor through the communications network;
gathering information from the item monitoring system during a first instance;
processing the information to determine the quantity of items within the first amount of space at a first instance;
gathering information from sources not related to the item monitoring system; and
adjusting the sales plan related to items based on the information from the item monitoring system and the sources not related to the item monitoring system.

11. The method of claim 10, further comprising the steps of:
recording the date and time when such information was gathered during the first instance.

12. The method of claim 10, further comprising the steps of:
gathering information from the item monitoring system during a second instance;
processing the information to determine the quantity of items within the first amount of space at the second instance and recording the date and time when the information was gathered during the second instance; and
determining a pattern of items leaving the first amount of space and determining the influence of the non-item monitoring system information on the pattern.

13. The method of claim 10, wherein the non-item monitoring system information may comprise one of the following: types of people shopping within the store; advertisement located adjacent to the first amount of space.

14. The method of claim 10, wherein the processing step comprises determining the location within the store of the first amount of space.

15. The method of claim 10, wherein adjusting the sales plan includes predicting when customers will most likely remove the items from the first amount of space and stocking items ahead of time to replenish the first amount of space with items.

16. The method of claim 10, wherein the sales plan may comprise one of the following: number of items ordered, shipped or received by the store; pricing of the items; or location of items within the store.

17. The method of claim 12, wherein the pattern is determined without the use of point of sales information.

18. The method of claim 10, wherein the plurality of items within the first amount of space are a plurality of the same stock-keeping unit.

19. A method of monitoring items within a store, comprising the steps of:
providing an item monitoring system, comprising:
a sensor, wherein the sensor senses a plurality of items in a first amount of space associated with the sensor, wherein the sensor is capable of sensing both items containing metal and items containing no metal;
a communications network; and
a computer, wherein the computer receives information from the sensor through the communications network;
gathering information from the item monitoring system;
processing the information to determine the quantity of items within the first amount of space;
gathering point-of-sale information related to the items, wherein the point-of sale information is gathered when items are sold and determine the quantity of items sold by the store;
determining the difference between quantity of items removed from the first amount of space and quantity of items sold by the store.

20. The method of claim 19, further comprising the step of:
activating an alarm to a user if there is a suspicion that some of the items have been stolen due to a large difference between the quantity of items removed from the first amount of space and the quantity of items sold by the store.

21. The method of claim 19 further comprising the step of:
recording the date and time when such information was gathered about the first amount of space.

22. The method of claim 19, wherein the processing step comprises determining the location of the first amount of space.
